(19) United States
(12) Patent Application Publication
(10) Pub. No.: US 2020/0314172 A1
(43) Pub. Date: Oct. 1, 2020

(54) SERVER SYSTEM AND MANAGEMENT METHOD THERETO

(71) Applicants: Inventec (Pudong) Technology Corporation, Shanghai (CN); Inventec Corporation, Taipei (TW)

(72) Inventors: Fang-Jie Chu, Shanghai (CN); Peng Zhan, Shanghai (CN)

(21) Appl. No.: 16/454,348

(22) Filed: Jun. 27, 2019

(30) Foreign Application Priority Data
Mar. 27, 2019 (CN) 201910239492.2

(51) Int. Cl. H04L 29/08; G06F 1/14; H04L 12/24

(52) U.S. Cl. CPC H04L 67/1008; H04L 41/24; H04L 67/1097; G06F 1/14

(57) ABSTRACT

The disclosure provides a server system, which comprises the following elements. A plurality of computing nodes and a plurality of storage nodes start to operate after the computing nodes and the storage nodes are actuated. A switch is electrically connected to the computing nodes through a plurality of first ports, and the switch is electrically connected to the storage nodes through a plurality of second ports. A rack management controller is electrically connected to the computing nodes, the storage nodes, and the switch. When the rack management controller receives a demand of hardware resource, the rack management controller controls the switch to connect to at least a part of the computing nodes and at least a part of the storage nodes according to the demand of hardware resource.

### CROSS-REFERENCE TO RELATED APPLICATIONS

This non-provisional application claims priority under 35 U.S.C. § 119(a) on Patent Application No(s). 201910239492.2 filed in China, R.O.C. on Mar. 27, 2019, the entire contents of which are hereby incorporated by reference.

### BACKGROUND

### 1. Technical Field

The disclosure relates to a server system and a management method thereto, more particularly to a server system and a management method thereto based on a rack management controller.

### 2. Related Art

As the era of “big data” is arrived, since the server has the advantages such as the powerful ability of calculation and the large memory for saving data and is able to supply the services for a plurality of external computing terminals through internet, there are more and more industries depend the server on dealing with large amount of data.

Generally, the physical characteristics (for example, the temperature, voltage and power supplement for each of the elements on the mainboard) of the computing node and the storage node of the server is monitored by the baseboard management controller (BMC). Also, the baseboard management controller sends the collected data to the rack management controller (RMC). Additionally, some kinds of the servers are able to directly monitor aforementioned characteristics by the rack management controller through the switch. Hence, the structures of said servers are simpler, and the cost is also lower since the baseboard management controller is not required to be configured.

However, since the structure of aforementioned server is limited by the factors such as the configuration of the elements and the specification of the switch, there are only one port connected between the switch, the rack management controller and each of the nodes. As a result, when one of the nodes or ports is damaged, the server is unable to switch the node through other ports or connect to another node via other ports, thereby the operating calculation is seriously affected.

For these reasons, it still needs a server system and a management method thereto to improve aforementioned problems.

### SUMMARY

According to one or more embodiment of this disclosure, a server system comprises: a plurality of computing nodes and a plurality of storage nodes configured to operate after the plurality of computing nodes and the plurality of storage nodes are actuated; a switch electrically connected to the plurality of computing nodes through a plurality of first ports respectively, and the switch electrically connected to the plurality of storage nodes through a plurality of second ports respectively; and a rack management controller electrically connected to the plurality of computing nodes, the plurality of storage nodes and the switch, with the rack management controller controlling the switch to connect at least a part of the plurality of computing nodes to at least a part of the plurality of storage nodes according to a demand of hardware resource when the rack management controller receives the demand of hardware resource.

According to one or more embodiment of this disclosure, a management method for a server system comprises: actuating a plurality of computing nodes and a plurality of storage nodes by a rack management controller; and controlling a switch to connect at least a part of the plurality of computing nodes to at least a part of the plurality of storage nodes by the rack management controller according to a demand of hardware resource when the rack management controller receives the demand of hardware resource.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is the block structure diagram of the server system in an embodiment of this disclosure.

FIG. 2 is the flowchart of the management method for the server system in an embodiment of this disclosure.

FIG. 3 is the detailed flowchart of the management method for the server system in an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

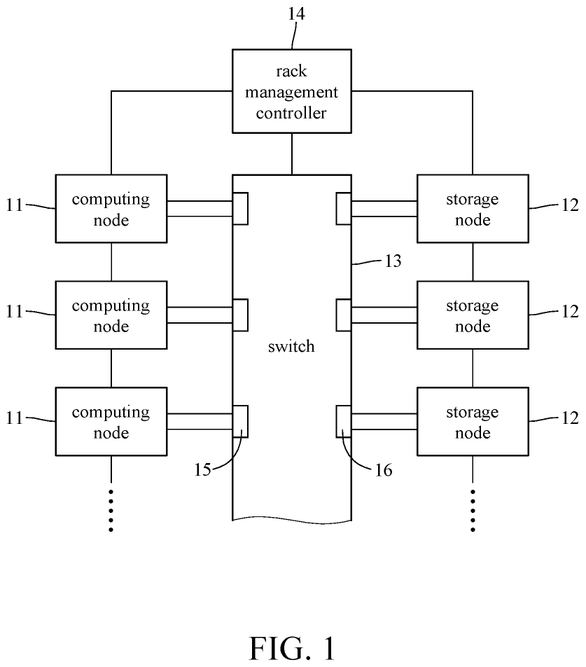

Please refer to FIG. 1. FIG. 1 is the block structure diagram of the server system in an embodiment of this disclosure. The server system comprises a plurality of computing nodes 11, a plurality of storage nodes 12, a switch 13 and a rack management controller (RMC) 14.

Please continue to refer to FIG. 1 for description of the computing nodes 11 and storage nodes 12. The computing nodes 11 and the storage nodes 12 start to operate when they are actuated. Furthermore, the way for actuating the computing nodes 11 and the storage nodes 12 may be receiving the instruction automatically sent from the server system, or may be receiving) the instruction entered by the user. The computing nodes 11 and the storage nodes 12 perform the corresponding operation (for example, the computing node 11 searches the data saved in the storage node 12 and calculates based on the data) when they receive the instruction. Specifically, the computing node 11 may be a central processing unit (CPU) or other elements having the calculating function. Also, the storage node 12 may be an error-correcting code memory (ECC memory), a registered memory (REG memory) or other elements having the storage function, and this disclosure is not limited thereto.

Please continue to refer to FIG. 1 for description of the switch 13. The switch 13 is connected to rack management controller 14 and each node through a plurality of ports. Particularly, the switch 13 is electrically connected to aforementioned computing nodes 11 respectively through a plurality of first ports 15. Also, the switch 13 is electrically connected to aforementioned storage nodes 12 respectively through a plurality of second ports 16. Additionally, the plurality of first ports 15 and the plurality of second ports 16 may be the ports whose hardware specifications support the inter-integrated circuit protocol (12C protocol). However, the plurality of first ports 15 and the plurality of second ports 16 also may be the ports whose the hardware specifications support other kinds of communications protocol according to different configurations of the server, and this embodiment is not limited thereto. In this embodiment, the switch 13 may be implemented by the SAS switch chip. Additionally, in an implementation of this embodiment, the model of aforementioned SAS switch chip is PM8056. However, the specification and the model of the switch 13 may be changed based on different configurations of the server, and this disclosure is not limited thereto.

Please continue to refer to FIG. 1 for description of the rack management controller 14. The rack management controller 14 is electrically connected to the plurality of computing nodes 11, the plurality of storage nodes 12 and the switch 13. Additionally, when the server is performing a boot procedure or receives an instruction, the rack management controller 14 may receive a demand of hardware resource. Furthermore, when the rack management controller 14 receives aforementioned demand of hardware resource, the rack management controller 14 is able to control the switch 13 to connect at least a part of the plurality of computing nodes 11 to at least a part of the plurality of storage nodes 12. For example, the demand of hardware resource may comprise a computational load and the data the calculation requiring. Hence, the rack management controller 14 is able to determine the required number of the computing nodes 11 according to the computational load, and the rack management controller 14 is able to select the storage node 12 according to aforementioned data. When the rack management controller 14 finishes in selection of the computing node 11 and storage node 12 that both are required for the calculation, the rack management controller 14 further control the switch 13 to connect the selected computing node 11 to the selected storage node 12. As a result, the plurality of computing nodes 11 are able to search the data saved in the plurality of storage nodes 12, and the plurality of computing nodes 11 are further able to perform the calculation based on the data saved in the plurality of storage nodes 12.

Hereinbefore, the plurality of computing node 11 may comprise a complex programmable logic device (CPLD), a real-time clock (RTC), a temperature sensor, a field-replaceable unit (FRU) or other elements which are able to collect data or supply additional function for the computing node 11 in practice. It is worth mentioning that the rack management controller 14 of this disclosure is able to collect the information (such as the temperature, voltage and firmware version of the CPLD) from each computing node 11 through the switch 13 without the baseboard management controller (BMC). Hence, the server system of this disclosure not only makes the structure of the server simpler, but also reduces the cost for maintaining the server.

On the other hand, when the computing node 11 is implemented by the complex programmable logic device (CPLD), the operating state of the computing node 11 is monitored by the rack management controller 14. Generally, in the structure of the server “monitoring each of the computing nodes by the BMC” mentioned in the conventional art, the complex programmable logic device (CPLD) is monitored by the BMC. Hence, the firmware of the complex programmable logic device (CPLD) supports the in-band updating in the conventional art. However, in an embodiment of this disclosure, the firmware of the complex programmable logic device (CPLD) supports both out-of-band updating and in-band updating. Particularly, the out-of-band updating is able to be performed as the firmware of the CPLD is sent to the switch 13 through the high speed topology network of the serial attached SCSI (SAS). On the other hand, the in-band updating is able to be performed as the firmware of the CPLD is sent to the switch 13 through the ports of the rack management controller 14; wherein the port may be implemented by the port whose hardware specification supports the I2C protocol. Additionally, in an implementation in this embodiment, aforementioned serial attached SCSI (SAS) may be implemented by the SAS 3.0. However, aforementioned serial attached SCSI (SAS) is also able to be implemented by other versions of SAS according to different transmission rate for different configurations, but this embodiment is not limited thereto. For these reasons, the server system disclosed by this disclosure improves the convenient to update the firmware of the CPLD, and the user can select the way to update the firmware of the CPLD flexibly.

Additionally, aforementioned serial attached SCSI (SAS) is a technique for computer hubs, wherein the main function thereof is transmitting data for the peripheral parts of the computer (such as the hard drive, CD-ROM, etc.). On the other hand, aforementioned SAS is a specification of the serial attached SCSI, wherein the SAS supports 2.5-inch hard drive and the SAS is adapted for the point-to-point serial protocol. The SAS 3.0 mentioned hereinbefore is the third-generation SAS, wherein the SAS 3.0 is able to provide a transmission rate of 12.0 Gbps (12000 Mbps) for each driver in the array.

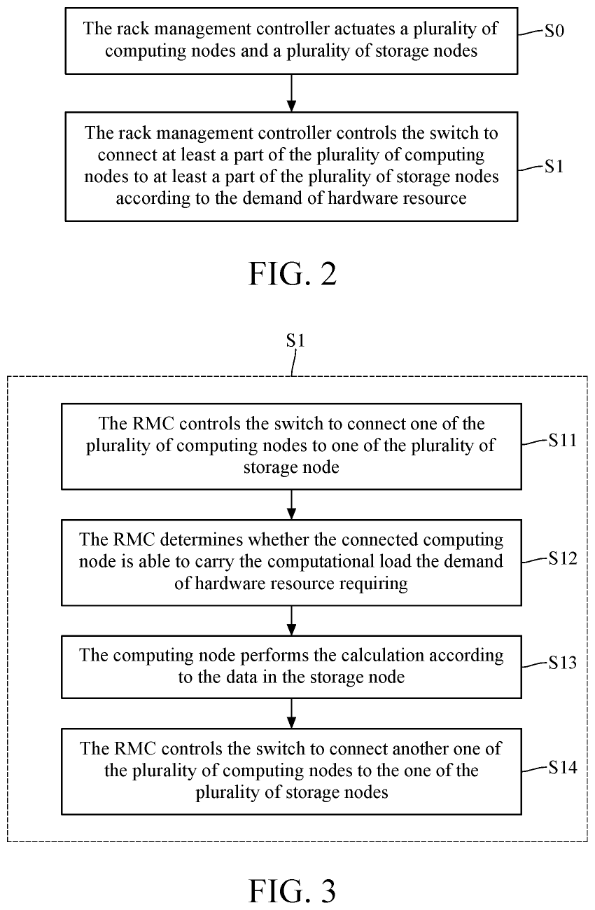

Please refer to FIG. 2. FIG. 2 is the flowchart of the management method for the server system in an embodiment of this disclosure. Please refer to the step S0: the rack management controller actuates a plurality of computing nodes and a plurality of storage nodes. Particularly, when the power of the server is turned on, the rack management controller is able to actuate the plurality of computing nodes and the plurality of storage nodes. Therefore, the plurality of computing nodes and the plurality of storage nodes are in the stand-by state and ready for the following operation. Please refer to the step S51. Once the server finishes the boot procedure and generates the instruction associated with the calculation, the rack management controller controls the switch to connect at least a part of the plurality of computing nodes to at least a part of the plurality of storage nodes according to the demand of hardware resource. Particularly, when the server generates the instruction associated with the calculation, the rack management controller receives the demand of hardware resource associated with the calculation, and the rack management controller selects the computing node and storage node that the current calculation requires according to the demand of hardware resource. When the rack management controller finishes in selection of the computing node and storage node that the current calculation requires, the rack management controller is able to further control the switch to connect the selected computing node to the selected storage node in order to performing the current calculation.

Please refer to FIG. 3. FIG. 3 is the detailed flowchart of the management method for the server system in an embodiment of this disclosure. Please refer to the step S11: when the rack management controller receives the demand of hardware resource, the rack management controller controls the switch to connect one of the plurality of computing nodes to one of the plurality of storage nodes. Specifically, said one of the plurality of computing nodes is the computing node selected by the rack management controller, said one of the plurality of storage nodes is the storage node selected by the rack management controller. Please refer to the step S12: when the rack management controller controls the switch to connect the one of the plurality of computing nodes to the one of the plurality of storage nodes, the rack management controller determines whether the connected computing node is able to carry the computational load which the demand of hardware resource requires, wherein the connected computing node is selected by the rack management controller. Please refer to the step S13: when the rack management controller determines the connected computing node is able to carry the computational load which the demand of hardware resource requires, the computing node performs the calculation according to the data in the storage node, and the operating state of the computing node is monitored by the rack management controller.

Please refer to the step S14: when the rack management controller determines the connected computing node is unable to carry the computational load which the demand of hardware resource requires, the rack management controller controls the switch to connect another one of the plurality of computing nodes to the one of the plurality of storage nodes. Particularly, when the computing node selected by the rack management controller current is unable to carry aforementioned computational load, the rack management controller needs to select another computing node according to current computational load from the computing nodes other than the one connected to the storage node in order to supply enough hardware resource for the current computational load. For these reasons, when the computational load of the server is increased suddenly (such as online shopping network congestion due to special festivals, or increased network traffic caused by special events hosted in the online games), the rack management controller is able to select more computing nodes currently through the switch according to the difference of the computational load. On the other hand, when the operating computing node or the corresponding port is damaged suddenly, the rack management controller is able to select other workable computing nodes or ports currently through the switch, and makes the current calculation can be continued.

In view of the above description, this disclosure provides a server system and management method thereto. The switch of the server system is able to connect the rack management controller to each of the nodes via a plurality of ports. When one of the ports is damaged, the rack management controller, via the switch and another port, is able to connect to the node originally connected to the damaged port and required during the calculation. Furthermore, the rack management controller is able to control the number of the operating computing nodes and storage nodes based on the difference of the demand of hardware resource. As a result, an efficient and flexible structure and method to manage the server system is provided by this disclosure, and the problems mentioned in the related art are able to be improved.

The embodiments depicted above and the appended drawings are exemplary and are not intended to be exhaustive or to limit the scope of the present disclosure to the precise forms disclosed. Many modifications and variations are possible in view of the above teachings.

What is claimed is:

1. A server system, comprising:
a plurality of computing nodes and a plurality of storage nodes configured to operate after the plurality of computing nodes and the plurality of storage nodes are actuated;
a switch electrically connected to the plurality of computing nodes through a plurality of first ports respectively, and the switch electrically connected to the plurality of storage nodes through a plurality of second ports respectively; and
a rack management controller electrically connected to the plurality of computing nodes, the plurality of storage nodes and the switch, with the rack management controller controlling the switch to connect at least a part of the plurality of computing nodes to at least a part of the plurality of storage nodes according to a demand of hardware resource when the rack management controller receives the demand of hardware resource.

2. The server system according to claim 1, wherein the rack management controller controls the switch to connect one of the plurality of computing nodes to one of the plurality of storage nodes according to the demand of hardware resource, and the rack management controller determines whether the computing node connected to the storage node is able to carry a computational load the demand of hardware resource requiring; the computing node operates according to data in the storage node when the rack management controller determines the computing node connected to the storage node is able to carry the computational load the demand of hardware resource requiring; and, when the rack management controller determines the computing node connected to the storage node is unable to carry the computational load the demand of hardware resource requiring, the rack management controller controls the switch to connect another one of the plurality of computing nodes to the one of the plurality of storage nodes.

3. The server system according to claim 1, wherein hardware specifications of the plurality of first ports and the plurality of second ports support inter-integrated circuit protocol.

4. The server system according to claim 1, wherein each of the plurality of computing nodes comprises a complex programmable logic device.

5. The server system according to claim 1, wherein each of the plurality of computing nodes comprises a real-time clock.

6. The server system according to claim 1, wherein each of the plurality of computing nodes comprises a temperature sensor.

7. The server system according to claim 1, wherein each of the plurality of computing nodes comprises a field-replaceable unit.

8. A management method for a server system, comprising:
actuating a plurality of computing nodes and a plurality of storage nodes by a rack management controller; and
controlling a switch to connect at least a part of the plurality of computing nodes to at least a part of the plurality of storage nodes by the rack management controller according to a demand of hardware resource when the rack management controller receives the demand of hardware resource.

9. The management method according to claim 8, wherein controlling the switch to connect the at least a part of the plurality of computing nodes to the at least a part of the plurality of storage nodes by the rack management controller according to the demand of hardware resource when the rack management controller receives the demand of hardware resource comprises:
controlling the switch to connect one of the plurality of computing nodes to one of the plurality of storage nodes by the rack management controller;
determining, by the rack management controller, whether the computing node connected to the storage node is able to carry a computational load which the demand of hardware resource requires;
performing calculation according to data in the storage node by the computing node when the rack management controller determines the computing node connected to the storage node is able to carry the computational load the demand of hardware resource requiring; and
controlling the switch to connect another one of the plurality of computing nodes to the one of the plurality of storage nodes by the rack management controller when the rack management controller determines the computing node connected to the storage node is unable to carry the computational load the demand of hardware resource requiring.

10. The management method according to claim 8, wherein the switch connects the plurality of computing nodes to the plurality of storage nodes through a plurality of inter-integrated circuit buses.
